(19) United States
(12) Patent Application Publication
(10) Pub. No.: US 2006/0077211 A1
(43) Pub. Date: Apr. 13, 2006

(54) Embedded device with image rotation

(76) Inventor: Mengyao Zhou, San Diego, CA (US)

Correspondence Address: QUALCOMM, INC, 5775 MOREHOUSE DR., SAN DIEGO, CA, 92121, US

(21) Appl. No.: 11/119,286

(22) Filed: Apr. 28, 2005

Related U.S. Application Data
(60) Provisional application No. 60/614,583, filed on Sep. 29, 2004.

(51) Int. Cl. G09G 5/00

(52) U.S. Cl. 345/650

(57) ABSTRACT

One embodiment of an embedded device comprises an angle of rotation defining mechanism and a rotation mechanism. The angle of rotation defining mechanism is adapted to define an arbitrary angle of rotation for an image. The rotation mechanism is adapted to apply a rotation transformation angle to the image using the arbitrary and using only integer arithmetic such that pixels within the image are mapped to rotated positions.

### CROSS REFERENCE TO RELATED APPLICATIONS

Priority is claimed to U.S. Provisional Application No. 60/614,583, filed on Sep. 29, 2004.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### BACKGROUND OF THE DISCLOSURE

Aspects of the disclosure relate to digital image manipulation. Other aspects relate to tools for rotating digital images in an embedded device—e.g., mobile phone.

Digital image manipulation may involve many different types of modifications and transformations performed on digital images. Examples of digital image manipulation techniques include rotation, magnification, pinching, warping, edge detection, and filtering.

In some applications, image manipulation operations such as rotation may help a user to understand an image from a certain perspective, or may orient an image for a specific use. In other applications, digital image manipulation, including rotation, may be performed for the sake of amusement. Digital image manipulation techniques are also used in industry, in applications including pattern recognition, feature extraction (e.g. in video surveillance and human motion analysis), image restoration, image enhancement, warping/morphing for computer animated sequences, and biomedical image processing.

A number of digital image manipulation techniques are commercially available in the form of photograph editing software. Embedded devices, such as digital cameras and mobile telephones, also have digital image manipulation functionality.

### BRIEF SUMMARY

One embodiment of an embedded device comprises an angle of rotation defining mechanism and a rotation mechanism. The angle of rotation defining mechanism is adapted to define an arbitrary angle of rotation for an image. The rotation mechanism is adapted to apply a rotation transformation angle to the image using the arbitrary and using only integer arithmetic such that pixels within the image are mapped to rotated positions.

### BRIEF DESCRIPTION OF THE DRAWINGS

Embodiments will be described with reference to the following drawing figures, in which like numerals represent like items throughout the figures, and in which:

FIG. 1 is a block diagram of an exemplary embedded device capable of performing a rotation image transformation;

FIG. 2 is a schematic diagram of an image before rotation, illustrating a coordinate system and angle of rotation;

FIG. 3 is a diagram of a coordinate plane illustrating the mapping of an arbitrary input angle of rotation to an angle between 0 and 90 degrees in a first case

FIG. 4 is a diagram of a coordinate plane illustrating the mapping of an arbitrary input angle of rotation to an angle between 0 and 90 degrees in a second case;

FIG. 5 is a diagram of a coordinate plane illustrating the mapping of an arbitrary input angle of rotation to an angle between 0 and 90 degrees in a third case;

FIG. 6 is a diagram of a coordinate plane illustrating the mapping of an arbitrary input angle of rotation to an angle between 0 and 90 degrees in a fourth case;

FIG. 7 is a block diagram of an exemplary embedded device capable of performing a rotation transformation using integer arithmetic;

FIG. 8 is a flow diagram of an exemplary method for performing a rotation transformation; and

FIG. 9 is an illustration of a mobile telephone with a digital camera adapted to perform rotation.

### DETAILED DESCRIPTION OF THE EXAMPLE EMBODIMENTS

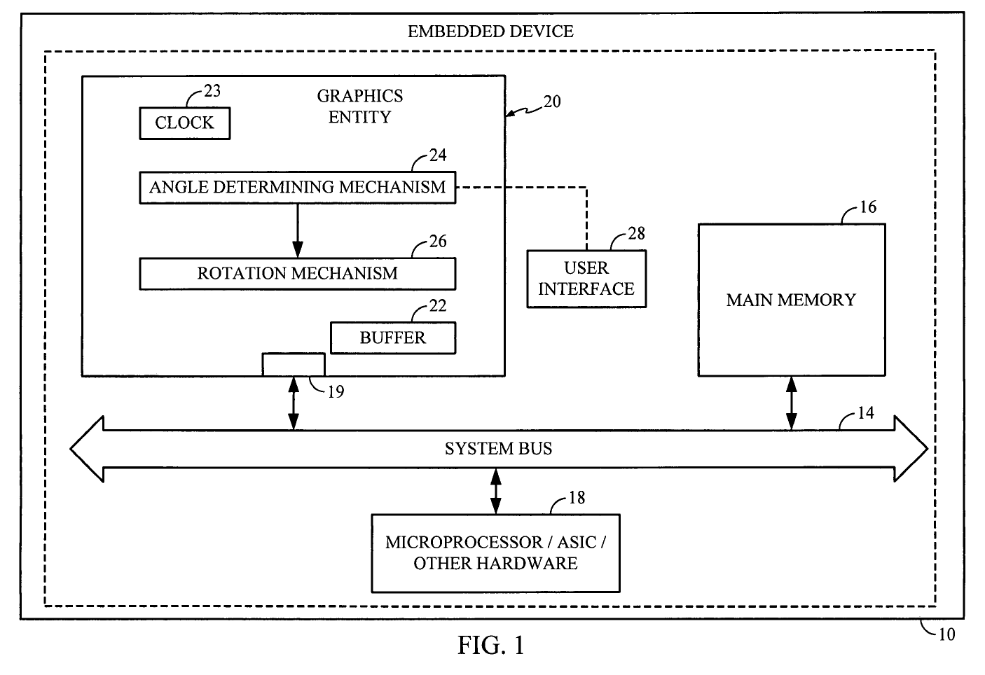

FIG. 1 is a block diagram of an exemplary embedded device 10, which, in the illustrated embodiment, comprises a wireless mobile communication device. The illustrated embedded device 10 comprises a system bus 14, a device memory 16 (which is a main memory in the illustrated device 10) connected to and accessible by other portions of the embedded device 10 through system bus 14, and hardware entities 18 connected to the system bus 14. At least some of the hardware entities 18 perform actions involving access to and use of main memory 16. The hardware entities 18 may include microprocessors, ASICs, and other hardware.

A graphics entity 20 is connected to the system bus 14. The graphics entity 20 may comprise a core or portion of a larger integrated system (e.g., a system on a chip (SoC)), or it may comprise a graphics chip, such as a graphics accelerator. In the illustrated embodiment, the graphics entity 20 comprises a graphics pipeline (not shown), a graphics clock 23, a buffer 22, and a bus interface 19 to interface graphics entity 20 with system bus 14.

Buffer 22 holds data used in per-pixel processing by graphics entity 20. Buffer 22 provides local storage of pixel-related data, such as pixel information from buffers (not shown) within main memory 16.

In the illustrated embodiment, graphics entity 20 also includes an angle-determining mechanism 24 and a rotation transformation mechanism 26. The angle-determining mechanism 24 is coupled to the user interface 28 of the device 10. The rotation mechanism 26 performs a rotation transformation on an image using an angle of rotation provided by the angle-determining mechanism 24. Although the graphics entity 20 performs the transformation functions in the illustrated embodiment, in other embodiments, those functions may be performed by the other hardware 18.

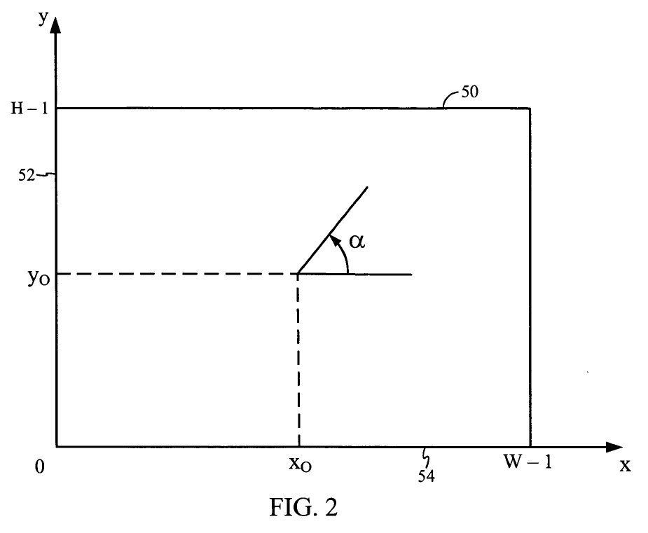

FIG. 2 is a schematic illustration of an image 50. The image 50 has a width W and a height H. In most digital image manipulation methods, the width W and height H are expressed in units of pixels, although other measurement units may be used. The height H of the image 50 extends along the y-axis 52 in FIG. 2, and the width W of the image extends along the x-axis 54. In FIG. 2, the width coordinates of the image 50 extend from 0 to W-1 and the height coordinates extend from 0 to H-1, as shown. Image 50 also has a center of rotation, indicated at coordinates (xₒ, yₒ).

Image 50 may be created in a number of ways, including digital photography, film photography followed by digitization, digitization from a non-photographic source, and pure digital illustration/rendering.

As indicated in FIG. 2, in the illustrated embodiment, image 50 is to be rotated about its center by an arbitrary angle of rotation α. The angle α may be any angle. In other embodiments, image 50 may be rotated about other points that are not the geometric center of the image.

Image 50 is rotated by mapping each pixel of the image to a new, rotated location using a set of transformation functions. For rotation, the transformation functions are represented by Equations (1) and (2) below:
xₒᵤₜ=xₒ+(xᵢₙ−xₒ)·cos θ−(yᵢₙ−yₒ)·sin θ (1)
yₒᵤₜ=yₒ+(xᵢₙ−xₒ)·sin θ+(yᵢₙ−yₒ)·cos θ (2)
wherein xᵢₙ and yᵢₙ are the input pixel coordinates, xₒᵤₜ and yₒᵤₜ are the output pixel coordinates, θ is the angle of rotation expressed in units of radians, and xₒ and yₒ are the coordinates of the center of rotation, which, in this case, is the center of image 50. Equations (1) and (2) can also be represented in matrix form as:

$$[ \begin{matrix}{x}_{out} - {x}_{o} \\ {y}_{out} - {y}_{o}\end{matrix} ] = [ \begin{matrix}cos θ & - sin θ \\ sin θ & cos θ\end{matrix} ] \cdot [ \begin{matrix}{x}_{i n} - {x}_{o} \\ {y}_{i n} - {y}_{o}\end{matrix} ] \qquad ( 3 )$$

As shown by Equation (3), the locations of the output pixels of image 50 may be directly calculated by performing the appropriate matrix multiplication. However, as shown, the calculation uses sine and cosine values for the angle of rotation. In some embodiments, sine and cosine values may be stored and retrieved using, for example, a look-up table (LUT). However, LUTs with sufficient numbers of sine and cosine values to handle arbitrarily specified angles of rotation may require a great deal of memory or storage space. Large amounts of space may not be available or desired on an embedded device.

Therefore, in the illustrated embodiment, the values of the sine and cosine functions for the angle of rotation are calculated. A first task in performing a rotation operation is to map the input desired angle of rotation (angle α) to an angle of rotation (angle β) in the range between 0 degrees and 90 degrees. This simplifies the calculations, because it takes advantage of the periodic nature of the sine and cosine functions.

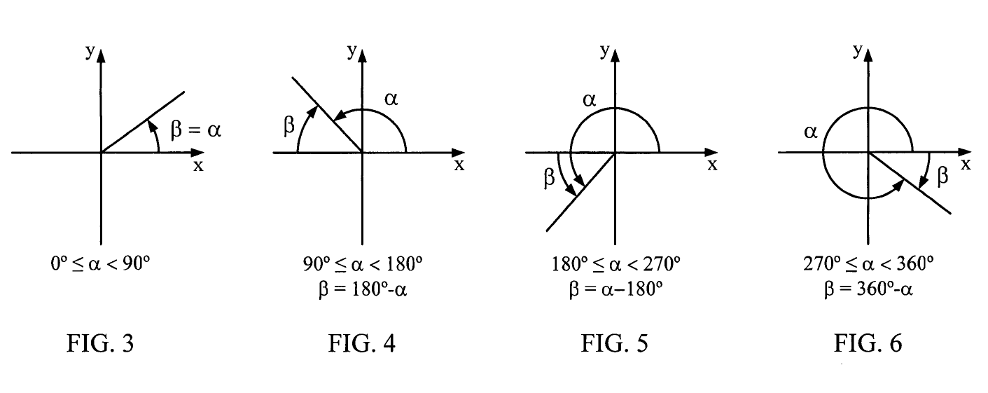

In this embodiment, four cases are considered when converting the angle α to an angle β in the range between 0 and 90 degrees. FIG. 3 illustrates a coordinate plane showing a first case, in which angle α is between 0 and 90 degrees. FIG. 4 illustrates a coordinate plane, showing a second case, in which angle α is between 90 and 180 degrees. In that case, angle β is set equal to 180 minus α. FIG. 5 illustrates a coordinate plane, showing a third case, in which angle α is between 180 and 270 degrees. In that case, angle β is set equal to α minus 180. In the fourth case, shown in the coordinate plane of FIG. 6, angle β is set equal to 360 minus α. If the angle α is greater than 360 degrees, 360 may be subtracted from angle α iteratively until α is in the range between 0 and 360 degrees. For angles that are multiples of 360, the rotated image is identical to the original image.

With the input angle α mapped to angle β, the sine and cosine relationships become:

$$\begin{matrix}If 0 ° \leq α < 90 ° , β = α and \{ \begin{matrix}sin α = sin β \\ cos α = cos β\end{matrix} & & ( 4 ) \\ If 90 ° \leq α < 180 ° , β = 180 ° - α and \{ \begin{matrix}sin α = sin ( 180 ° - β ) \\ cos α = - cos ( 180 ° - β )\end{matrix} & & ( 5 ) \\ If 180 ° \leq α < 270 ° , β = α - 180 ° and \{ \begin{matrix}sin α = - sin ( β - 180 ° ) \\ cos α = - cos ( β - 180 ° )\end{matrix} & & ( 6 ) \\ If 270 ° \leq α < 360 ° , β = 360 ° - α and \{ \begin{matrix}sin α = - sin ( 360 ° - β ) \\ cos α = cos ( 360 ° - β )\end{matrix} . & & ( 7 )\end{matrix}$$

In the illustrated embodiment, the values of the sine and cosine functions are approximated using Taylor series. For a sine function, the Taylor series expansion is:

$$sin θ = θ - \frac{1}{3 !} {θ}^{3} + \frac{1}{5 !} {θ}^{5} - \frac{1}{7 !} {θ}^{7} + ⋯ , \qquad ( 8 )$$

and for a cosine function, the Taylor series expansion is:

$$cos θ = 1 - \frac{1}{2 !} {θ}^{2} + \frac{1}{4 !} {θ}^{4} - \frac{1}{6 !} {θ}^{6} + ⋯ , \qquad ( 9 )$$

in which θ is the angle β converted to units of radians. As in any use of a Taylor series, the approximation becomes more accurate as more terms are added. However, the more terms of a Taylor series that are used, the more computationally expensive the process becomes. Additionally, successive terms of a Taylor series add ever more diminishing amounts of accuracy to the final result. Therefore, the number of Taylor series terms that are used to calculate the power function will depend on the accuracy desired as well as the computing power available.

The amount of accuracy in sine and cosine values and the corresponding number of Taylor series terms used in a particular application may vary. In some display applications, not much accuracy may be required, whereas in image analysis or other high-performance applications, a great deal of accuracy may be required. One way to decide how many terms to use is to set an accuracy threshold, for example, that approximated sine and cosine values must be within 5% of the actual values, and to then find the number of Taylor series terms for each function that produces the desired accuracy level. In the illustrated embodiment, different numbers of Taylor series terms are used for different angles. That is, sine and cosine values in the illustrated embodiment are calculated using Equations (10) and (11) below:

$$\begin{matrix}sin θ ≅ \{ \begin{matrix}θ - \frac{1}{3 !} {θ}^{3} & if 0 ° \leq β \leq 40 ° , θ = β \cdot \frac{π}{180 °} \\ θ - \frac{1}{3 !} {θ}^{3} + \frac{1}{5 !} {θ}^{5} - \frac{1}{7 !} {θ}^{7} & if 40 ° < β \leq 90 ° , θ = β \cdot \frac{π}{180 °}\end{matrix} , & ( 10 ) \\ cos θ = \{ \begin{matrix}1 - \frac{1}{2 !} {θ}^{2} & if 0 ° \leq β \leq 40 ° , θ = β \cdot \frac{π}{180 °} \\ 1 - \frac{1}{2 !} {θ}^{2} + \frac{1}{4 !} {θ}^{4} - \frac{1}{6 !} {θ}^{6} & if 40 ° < β \leq 90 ° , θ = β \cdot \frac{π}{180 °}\end{matrix} , & ( 11 )\end{matrix}$$

As shown in Equations (10) and (11), the number of terms used to approximate the sine and cosine functions increases from two to four as angle β increases beyond 40 degrees because it was found that in the illustrated embodiment, two Taylor series terms are sufficient to approximate the functions to within 5% accuracy for angles less than 40 degrees, whereas the accuracy of a two-term series decreases beyond 40 degrees. Other embodiments may use different thresholds.

The illustrated image rotation methods may be implemented to run on a computing system of limited capabilities, such as an integer microprocessor. Integer microprocessors are commonly used on mobile devices, such as mobile telephones, mobile telephones with digital cameras, and other portable computing devices. While integer microprocessors typically include a floating-point (i.e., decimal) mathematics emulator, it can be more time consuming and computationally expensive to use the emulator. The transformations may be implemented using integer arithmetic.

When implementing transformation equations such as Equations (1) and (2) on an integer microprocessor using the Taylor series approximations of Equations (10) and (11) to calculate sine and cosine functions, two considerations arise: the calculation of those equations using only integer arithmetic with accuracy, and the ordering of operations so as to avoid integer overflow (i.e., the condition in which a calculated number exceeds the largest integer that the microprocessor can handle).

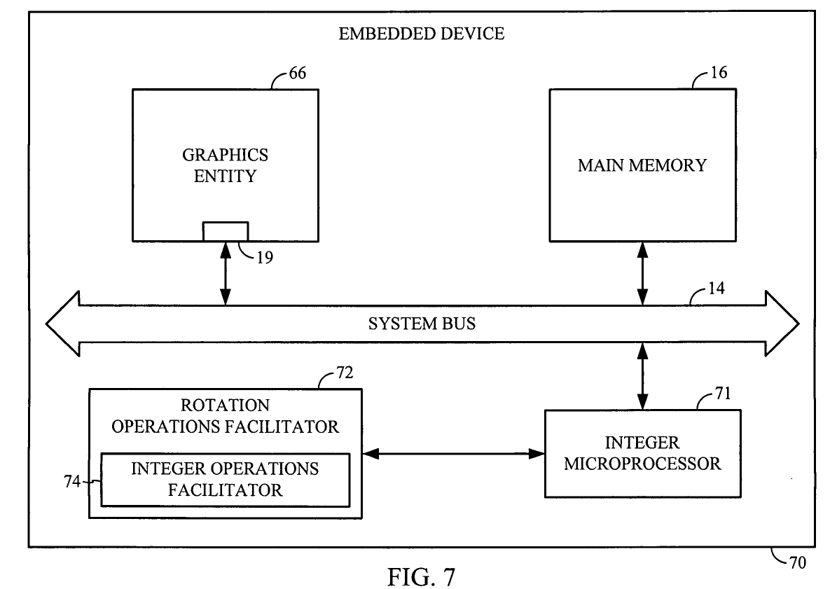

FIG. 7 is a block diagram of an exemplary embedded device 70 that is adapted to perform the transformations described above using integer arithmetic. The embedded device 70 includes a main memory 16 connected to a system bus 14, a graphics entity 76 connected by an interface 19 to the system bus 14, and an integer microprocessor 71 connected to the system bus 14. Embedded device 70 also includes a rotation operations facilitator 72 connected to the microprocessor. An integer operations facilitator 74 is included within the rotation operations facilitator 72.

The rotation operations facilitator 72 calculates the sine and cosine functions of Equations (1) and (2) using the approximations of Equations (10) and (11) and performs the other rotation operations. The integer operations facilitator 74 ensures that all of the necessary calculations are performed using integer arithmetic with an order of calculation that avoids integer overflow. The operation of both components 72, 74 and the calculations performed will be described below in more detail. An advantage of an embedded device such as device 70 is that no floating-point emulator is used, which makes the transformations more efficient on the integer microprocessor 71. The rotation operations facilitator 72 and integer operations facilitator 74 may be implemented in hardware, in software, in some combination of hardware and software, or in any other way compatible with the embedded device 70.

Equations (10) and (11) do not contain strictly integer terms, but the terms of those equations can be converted so that the calculations can be performed using integer arithmetic. For example,

$$\frac{1}{3 !}$$

can be first computed as a real number, then multiplied by 2¹⁰=1024, and finally rounded to an integer. Thus,

$$\frac{1}{3 !}$$

can be converted to

$$\frac{1}{3 !} \cdot {2}^{10} = ( 0.16667 ) \cdot 1024 = 171.$$

Intermediate arithmetic operations can be calculated using this new integer representation of

$$\frac{1}{3 !} .$$

After all intermediate operations are complete, the final result can be obtained by dividing by 2¹⁰. This technique preserves accuracy during intermediate integer arithmetic operations. Similarly, other non-integer terms such as

$$\frac{1}{5 !}$$

can be converted to integers in the same manner to obtain accurate results using purely integer arithmetic. In general, large powers of two are used to maintain a reasonable number of significant digits, which helps to maintain accuracy. However, smaller powers of two may be used as multipliers if less accuracy is needed. Additionally, although powers of other integral numbers may be used as multipliers, the use of powers of two allows the use of faster bit-shifting operations, rather than relatively slower multiplication operations.

As one implementation example, the following code illustrates an implementation of the described rotation methods on a 32-bit integer microprocessor:

uint32 w, h, beta, radian;
int8 sinSign, cosSign;
int32 xin, yin, xout, yout, xo, yo, sintheta, costheta;
xo = w >> 1;
yo = h >> 1;
sinSign = 1;
cosSign = 1;
/* angle is an int32 input parameter indicating the rotation angle */
while (angle < 0) {

angle += 360;

}
angle %= 360;
/* map angle to range [0, 90] degrees */
if (angle <= 90) {

beta = angle;

} else if (angle <= 180) {

beta = 180 − angle;
cosSign = −1;

} else if (angle <= 270) {

beta = angle − 180;
sinSign = −1;
cosSign = −1;

} else {

beta = 360 − angle;
sinSign = −1;

}
/* convert angle to radians * 2\hat{ }9 */
radian = beta * 9;
/* calculate sin and cos */
if (radian <= 360) {

/* beta <= 40 degrees */
sintheta = ((radian*(262144−(radian*radian)/6))>>8)*sinSign;
costheta = (524288−radian*radian)*cosSign;

} else {

if (radian == 810) {

/* beta = 90 degrees */
sintheta = 524288*sinSign;
costheta = 0;

} else {

/* 40 < beta < 90 */
sintheta = (((radian*(262144−(radian*radian)/6))>>8) +

(((((((((radian*radian*radian)/120)>>3)*
radian)>>10)*radian)/42)*((11010048−
radian*radian)>>10))>>21))*cosSign;

costheta = ((524288−radian*radian) +

(((((((radian*radian*radian)/24)>>3)
*radian/30)>>10)*((7864320−
radian*radian)>>10))>>12))*cosSign;

}

}
/* for each output pixel, map to the corresponding input pixel */
xin = xo+(((xout−xo)*costheta + (yout−yo)*sintheta)>>19);
yin = yo+(((xo−xout)*sintheta + (yout−yo)*costheta)>>19);

In the above code, the variable w is the width of the image, the variable h is the height of the image, and angle is the angle of rotation stored as a 32-bit integer. The above code snippet is in the C programming language, although other embodiments of the rotation methods described here may be implemented in C++, Java, J++, assembler, or any other programming language capable of executing the commands. In order to facilitate real-time performance, in the embodiment shown, e.g., no integers larger than the 32-bit capacity of the microprocessor are used. The order of operations in the above code is such that no integer in the calculations will be larger than 32-bits. Although implemented here for a 32-bit microprocessor, these rotation methods may be implemented for other microprocessors, including 64- and 128-bit microprocessors, as well as on any other computing device, such as an ASIC, capable of performing the calculations. The rotation operations described herein, although described in terms of an integer microprocessor, can also be executed on a microprocessor capable of floating-point operations.

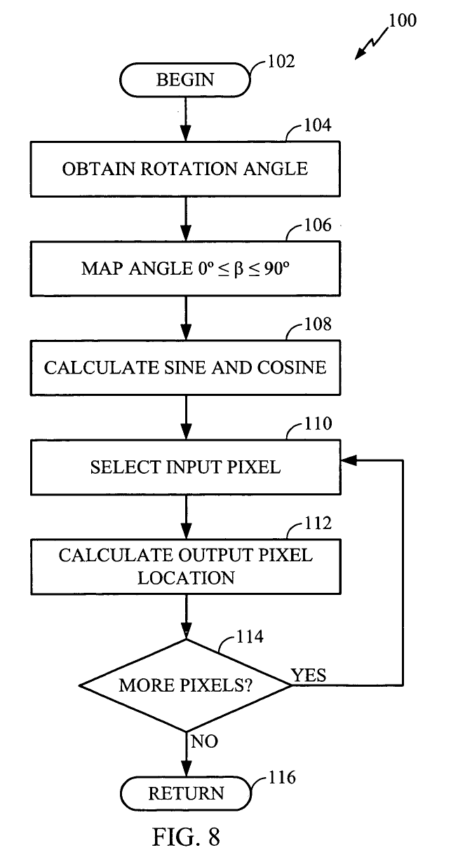

A more generalized method 100 of performing the rotation transformation is shown in FIG. 8, a flow diagram. Method 100 begins processing the input image at act 102 and continues with act 104. At act 104, method 100 obtains the angle of rotation α. The manner in which the angle of rotation α is obtained depends on the type of user interface available on the platform on which method 100 is performed. In some embodiments, a user may input an angle using numerical keystrokes. In other embodiments, a user may indicate the angle of rotation using some combination of keys other than numerical. Alternatively, if method 100 is implemented as a method of performing the same rotation transformation on a number of images, the angle α may be encoded in the instructions for performing the method, in which case act 104 may comprise retrieving angle α from storage. Once the angle α has been obtained, method 100 continues with act 106.

In act 106, the angle α is mapped as was described above to an angle β in the range between 0 and 90 degrees. Once act 106 is complete, method 100 continues with S108, in which the sine and cosine functions for the angle β are calculated using appropriate Taylor series approximations. After the sine and cosine functions for the angle are calculated, method 100 continues with act 110, in which a pixel in the input image is selected. Once the pixel is selected, act 112 is performed, in which the location of an output pixel is calculated. Control of method 100 then passes to act 114, where it is determined whether additional input pixels need to be processed. If additional input pixels need to be processed (114: YES), control of method 100 returns to act 110 and processing of input pixels continues. When no more pixels remain to be transformed (114: NO), control of method 100 passes to act 116, where the method terminates and returns. After method 100 completes and returns, any additional tasks useful, for example, in outputting the final rotated image may be performed.

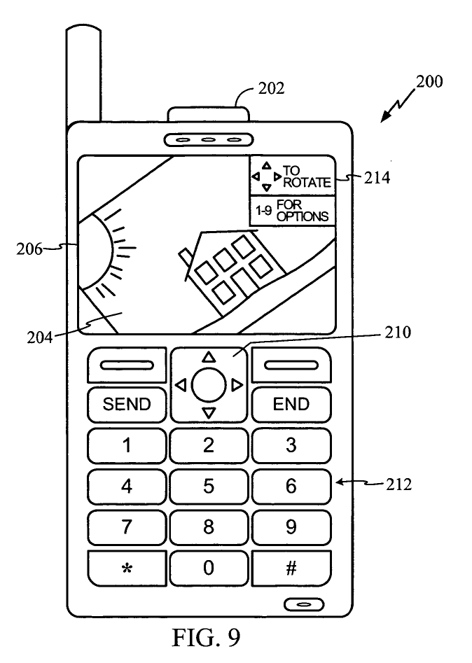

FIG. 9 illustrates an image displayed on the screen of a mobile phone, after a counterclockwise rotation about the geometric center of the image. Pixel areas of the transformed image that are outside of the original dimensions of the image of FIG. 9 are clipped and unused areas of the image have black pixel values. In other embodiments, the image may be resized so that every pixel appearing in the original image also appears in the rotated image. Unused pixels in the rotated image may be given colors or properties other than black, and if an image format is used that supports pixel transparency, those pixels may be indicated as being transparent.

In some of the foregoing description, it has been assumed that the image to be rotated is in the RGB (red-green-blue) format, in which each image pixel has a value for the red content of that pixel, a value for the green content, and a value for the blue content. However, the illustrated transformation methods can be used directly on other image formats without first converting to RGB. This is advantageous because although RGB-format images are relatively easy to manipulate, they are more difficult to compress, and generally consume more storage space.

Two other common image formats are YCbCr and YCrCb. Whereas in an RGB image, data is stored in terms of the red, green, and blue color values for each pixel, the YCbCr and YCrCb formats store image data by recording the luminance (Y) and chrominance (Cb, Cr) values for each pixel. The YCbCr and YCrCb formats are popular because they are used in the common JPEG picture file format.

The ability to operate on RGB, YCbCr, and YCrCb images is advantageous if image transformations, such as rotation, are implemented on a portable embedded device such as a digital camera, because all three formats may be used in a digital camera. This is because of the way digital images are created and processed.

For example, most digital camera image sensors are composed of individual sensor cells that are sensitive to only one of red, green, or blue light, not to light of all three colors. Therefore, individual cells are typically arranged in a pattern, called a Bayer pattern, in which cells sensitive to green are dispersed among and alternated with cells sensitive to red and blue. In consumer products, green cells usually predominate because the human visual system is more sensitive to green, and the inclusion of more green cells tends to increase the perceived image quality. In one typical Bayer pattern, an array of 16 cells may include 8 green cells, 4 red cells, and 4 blue cells arranged roughly in a checkerboard pattern. When an image is taken by a digital device that uses single-color cells in a Bayer pattern, the raw image is typically interpolated such that each pixel has a red value, a green value, and a blue value and stored, at least in an intermediate stage of processing, as an RGB image. The image may be further converted to YCbCr or YCrCb for storage.

Although images in YCbCr and YCrCb formats may be directly processed by applying the rotation transformation methods described above, there are some circumstances in which additional tasks may be performed, for example, with subsampled YCbCr and YCrCb images. In a subsampled image, some chrominance values are discarded or subsampled in order to reduce the size of the file. For example, in the common H2V1 YCbCr 4:2:2 format, pixel columns are subsampled, but pixel rows are unaffected. In this subsampling scheme, if the columns are numbered starting from zero, only even columns have the Cb component and only odd columns have the Cr component. Another subsampled format is the YCbCr 4:2:0 format, in which each 2×2 pixel array shares a single Cb value and a single Cr value. YCrCb format is generally the same as YCbCr, except that the order of Cb and Cr values is reversed.

The transformation methods described above may be directly applied to subsampled YCbCr and YCrCb formats, although doing so may not result in an end image with correctly alternating Cb and Cr components. To overcome this issue, a temporary unsubsampled image (YCrCb 4:4:4 or YCbCr 4:4:4) may be created from the subsampled image by considering pairs of adjacent pixels and duplicating the appropriate Cb and Cr values so that each pixel has a Cb and a Cr value. The transformation methods described above are then applied to the temporary unsubsampled image to produce a temporary unsubsampled output image. After transformation, the extra Cb and Cr values in the subsampled output image are discarded. Tests performed by the inventor showed no visually perceptible differences between the processing of an RGB image and the processing of that same image in YCbCr and YCrCb formats.

FIG. 11 shows an embodiment of a mobile phone 200 with a digital camera 202. Mobile phone and digital camera are each types of embedded devices. The mobile telephone 200 and its digital camera 202 include mechanisms for performing image transformations as described herein. In typical use, a user would take a digital picture using the digital camera 202 of the mobile telephone 200, and would then use the processing capabilities of the mobile telephone 200 to perform a rotation. As shown in FIG. 11, a digital image 204 is displayed on the display screen 206 of the mobile telephone 200. The display screen 206 may, e.g., be a relatively small liquid crystal display. As shown, the image 204 has been rotated counterclockwise. An overlay or pull-down menu 214 temporarily overlaid on the image 204 may provide instructions for additional rotation. For example, the user may be instructed to use the arrow keys 210 of the mobile telephone 204 to increase or decrease the angle of rotation. Each keypress could be programmed to correspond with an increase or decrease in angle of rotation of 1 or 2 degrees. When the angle of rotation is changed, the transformation is repeated, with a new angle of rotation. The new angle of rotation may be an angle of rotation given relative to the current position of the image, or relative to its original position. The user may also specify the angle of rotation using the numerical keys 212.

While certain illustrated embodiments have been described, the words which have been used herein are words of description rather than words of limitation. Changes may be made, e.g., within the purview of the appended claims.

What is claimed is:

1. An embedded device, comprising:
an angle of rotation defining mechanism to define an angle of rotation for an image; and
a rotation mechanism to apply a rotation transformation to the image using the angle and using only integer arithmetic such that pixels within the image are mapped to rotated positions.

2. The device of claim 1, further comprising a user interface coupled to the angle of rotation defining mechanism to acquire the angle of rotation.

3. The device of claim 1, wherein the angle of rotation defining mechanism is adapted to map the angle of rotation α to a mapped angle of rotation β, and the rotation mechanism uses the mapped angle of rotation in applying the rotation transformation.

4. The device of claim 3, wherein the mapped angle of rotation β satisfies the inequality 0°≦β≦90°.

5. The device of claim 4, wherein the rotation transformation is represented by a matrix transformation:
$$[ \begin{matrix}{x}_{out} - {x}_{o} \\ {y}_{out} - {y}_{o}\end{matrix} ] = [ \begin{matrix}cos θ & - sin θ \\ sin θ & cos θ\end{matrix} ] \cdot [ \begin{matrix}{x}_{in} - {x}_{o} \\ {y}_{in} - {y}_{o}\end{matrix} ]$$
wherein xᵢₙ and yᵢₙ are location coordinates for a pixel of the image, xₒᵤₜ and yₒᵤₜ are location coordinates for the rotated position of the pixel, xₒ and yₒ are location coordinates for a center of rotation of the rotation transformation, and θ is the mapped angle of rotation β expressed in units of radians.

6. The device of claim 5, wherein the relationship between the angle of rotation a and the mapped angle of rotation β are represented by the following equations:
$$\begin{matrix}If 0 ° \leq α < 90 ° , β = α and \{ \begin{matrix}sin α = sin β \\ cos α = cos β\end{matrix} \\ If 90 ° \leq α < 180 ° , β = 180 ° - α and \{ \begin{matrix}sin α = sin ( 180 ° - β ) \\ cos α = - cos ( 180 ° - β )\end{matrix} \\ If 180 ° \leq α < 270 ° , β = α - 180 ° and \{ \begin{matrix}sin α = - sin ( β - 180 ° ) \\ cos α = - cos ( β - 180 ° )\end{matrix} \\ If 270 ° \leq α < 360 ° , β = 360 ° - α and \{ \begin{matrix}sin α = - sin ( 360 ° - β ) \\ cos α = cos ( 360 ° - β )\end{matrix} .\end{matrix}$$

7. The device of claim 5, wherein the rotation mechanism approximates the values of the sine and cosine functions of the matrix transformation to obtain values accurate to within a desired accuracy threshold.

8. The device of claim 7, wherein the rotation mechanism approximates the values of the sine and cosine functions of the matrix transformation using one or more terms of Taylor series sine and cosine approximations.

9. The device of claim 8, wherein the rotation mechanism uses a first number of Taylor series terms if the mapped angle of rotation β is below a threshold angle and a second number of Taylor series terms of the mapped angle of rotation β is above the threshold angle.

10. The device of claim 1, wherein the rotation mechanism includes an integer operations facilitator adapted to convert non-integer terms to integers and to perform calculations in an order of calculation that prevents integer overflow.

11. The device of claim 1, wherein the embedded device is a mobile phone.

12. A machine-readable medium encoded with data, the data being interoperable with a machine to cause:
defining an angle of rotation for an image; and
applying a rotation transformation using the angle to the image using only integer arithmetic such that pixels within the image are mapped to rotated positions.

13. The medium of claim 12, wherein the data is interoperable with a machine to further cause mapping the angle of rotation β and using the mapped angle of rotation in applying the rotation transformation.

14. The medium of claim 13, wherein data is interoperable with a machine to cause the mapped angle of rotation β to satisfy the inequality 0°≦β≦90°.

15. The medium of claim 14, wherein the data is interoperable with a machine to cause the rotation transformation to be represented by a matrix transformation:
$$[ \begin{matrix}{x}_{out} - {x}_{o} \\ {y}_{out} - {y}_{o}\end{matrix} ] = [ \begin{matrix}cos θ & - sin θ \\ sin θ & cos θ\end{matrix} ] \cdot [ \begin{matrix}{x}_{in} - {x}_{o} \\ {y}_{in} - {y}_{o}\end{matrix} ]$$
wherein xᵢₙ and yᵢₙ are location coordinates for a pixel of the image, xₒᵤₜ and yₒᵤₜ are location coordinates for the rotated position of the pixel, x₀ and yₒ are location coordinates for a center of rotation of the rotation transformation, and θ is the mapped angle of rotation β expressed in units of radians.

16. The device of claim 15, wherein the data is interoperable with a machine to cause the relationship between the arbitrary angle of rotation α and the mapped angle of rotation β to be represented by:
$$\begin{matrix}If 0 ° \leq α < 90 ° , β = α and \{ \begin{matrix}sin α = sin β \\ cos α = cos β\end{matrix} \\ If 90 ° \leq α < 180 ° , β = 180 ° - α and \{ \begin{matrix}sin α = sin ( 180 ° - β ) \\ cos α = - cos ( 180 ° - β )\end{matrix} \\ If 180 ° \leq α < 270 ° , β = α - 180 ° and \{ \begin{matrix}sin α = - sin ( β - 180 ° ) \\ cos α = - cos ( β - 180 ° )\end{matrix} \\ If 270 ° \leq α < 360 ° , β = 360 ° - α and \{ \begin{matrix}sin α = - sin ( 360 ° - β ) \\ cos α = cos ( 360 ° - β )\end{matrix} .\end{matrix}$$

17. The medium of claim 15, wherein the data is interoperable with a machine to cause approximating the values of the sine and cosine functions of the matrix transformation to obtain values accurate to within a desired accuracy threshold.

18. The medium of claim 17, wherein the data is interoperable with a machine to cause approximating the values of the sine and cosine functions of the matrix transformation using one or more terms of Taylor series sine and cosine approximations.

19. The medium of claim 18, wherein the data is interoperable with a machine to cause using a first number of Taylor series terms if the mapped angle of rotation β is below a threshold angle and a second number of Taylor series terms of the mapped angle of rotation β is above the threshold angle.

20. The medium of claim 12, wherein the data is interoperable with a machine to cause converting non-integer terms to integers and performing calculations in an order of calculation that prevents integer overflow.

21. Apparatus comprising:
an embedded device;
means within the embedded device for defining an angle of rotation for an image; and
means within the embedded device for applying a rotation transformation using the angle to the image using only integer arithmetic such that pixels within the image are mapped to rotated positions.

22. The apparatus of claim 21, further comprising means for mapping the angle of rotation α to a mapped angle of rotation β and using the mapped angle of rotation in applying the rotation transformation.

23. The apparatus of claim 22, wherein the rotation transformation is represented by a matrix transformation:
$$[ \begin{matrix}{x}_{out} - {x}_{o} \\ {y}_{out} - {y}_{o}\end{matrix} ] = [ \begin{matrix}cos θ & - sin θ \\ sin θ & cos θ\end{matrix} ] \cdot [ \begin{matrix}{x}_{in} - {x}_{o} \\ {y}_{in} - {y}_{o}\end{matrix} ]$$
wherein xᵢₙ and yᵢₙ are location coordinates for a pixel of the image, xₒᵤₜ and yₒᵤₜ are location coordinates for the rotated position of the pixel, xₒ and yₒ are location coordinates for a center of rotation of the rotation transformation, and θ is the mapped angle of rotation β expressed in units of radians.

24. The apparatus of claim 23, further comprising means for approximating the values of the sine and cosine functions of Equation (1).

25. The apparatus of claim 23, wherein the means for approximating approximate the values of the sine and cosine functions of Equation (1) using a first level of accuracy for a first range of the mapped angle of rotation β and a second level of accuracy for a second range of the mapped angle of rotation β.

26. A mobile phone, comprising:
a receiver/transmitter assembly;
a microprocessor;
an angle of rotation defining mechanism to define an angle of rotation for an image; and
a rotation mechanism to apply a rotation transformation using the angle to the image using only integer arithmetic such that pixels within the image are mapped to rotated positions.

27. The mobile phone of claim 26, wherein the microprocessor is an integer microprocessor.

28. The mobile phone of claim 27, further comprising a keypad and a display screen.

29. The mobile phone of claim 28, further comprising a digital camera.
